(19) United States
(12) Patent Application Publication
(10) Pub. No.: US 2003/0065525 A1
(43) Pub. Date: Apr. 3, 2003

(54) Systems and methods for providing beauty guidance

(76) Inventors: Daniella Giacchetti, Paris (FR); Gilles Rubinstenn, Paris (FR)

Correspondence Address: FINNEGAN, HENDERSON, FARABOW, GARRETT & DUNNER, L.L.P., 1300 I Street, N.W., Washington, DC, 20005-3315, US

(21) Appl. No.: 10/024,621

(22) Filed: Dec. 21, 2001

Related U.S. Application Data
(60) Provisional application No. 60/325,559, filed on Oct. 1, 2001.

(51) Int. Cl. G06F 17/60

(52) U.S. Cl. 705/1

(57) ABSTRACT

Providing guidance for a subject may include receiving profile information about the subject, the profile information reflecting at least one of physical attribute information and lifestyle information. Information may also be received reflecting a birth-related classification of the subject, such as an identification of the subject's astrological horoscope sign. Thereafter, guidance may be provided for the subject, the guidance at least including beauty advice and being a function of at least some of the profile information and the subject's birth-related classification.

### BACKGROUND OF THE INVENTION

1. Field of the Invention

The present invention relates to the field of providing guidance. More particularly, in various specific embodiments, the invention uses profile information about a subject together with a birth-related classification, such as an astrological horoscope sign of the subject, as a basis for providing beauty advice.

2. Description of Related Art

Astrology, meaning “science of the stars”, is the study of the influence of stars on human behavior, traits, and experiences. Since the earliest of times people have divided the zodiac, meaning “circle of animals”, into 12 equal parts called Houses. These Houses are known as the 12 signs of the Zodiac. The 12 signs are then divided into two groups, six masculine: Aries; Gemini; Leo; Libra; Sagittarius; and Aquarius, and six feminine: Taurus; Cancer; Virgo; Scorpio; Capricorn; and Pisces. Although the sun and the moon are actually luminaries, in astrology, they are known as planets.

According to astrology, the sun's position at the time of a subjects birth, rules the subject's personality, and how the subject goes about everyday life. In addition, it is believed in astrology that the sun's position at the time of a subject's birth determines the subject's many characteristics and how others may perceive the subject. The Moon and the other planets in astrology have their constant effects on subjects as well as keeping subjects forever evolving and experiencing new insight.

The Babylonians are generally credited with the birth of astrology. Their astrological charts enabled them to predict the recurrence of seasons and certain celestial events. Thus in the beginning, and for more than 2,000 years, astrology and astronomy overlapped. Babylonian astrology was introduced to the Greeks early in the 4th century B.C. Through the studies of Plato, Aristotle, and others, astrology came to be regarded by some as a science. Astrology was soon embraced by the Romans (the Roman names for the zodiacal signs are still used today), then the Arabians, and eventually spread throughout most of the world.

While early astrology was used to bring a sense of order out of apparent chaos, it was soon utilized in attempts to predict weather patterns primarily for agricultural purposes. Astrology was eventually broadened to include forecasts of natural disasters, wars, and other events in the course of human endeavor.

The zodiac is believed to have developed in ancient Egypt and later adopted by the Babylonians. Early astrologers knew it took twelve lunar cycles (months) for the sun to return to its original position. They then identified twelve constellations that they observed as being linked to the progression of the seasons and assigned them names of certain animals and persons. In Babylon, for example, the rainy season occurred when the sun was in a particular constellation which was then named Aquarius, or water bearer.

The signs of the zodiac are subdivided into four groups. Each of these four groups is inscribed in its own quadrant, or “house”, on a circle. In astrology, the division of the twelve houses is based on the earth's daily rotation and relates, for example, to such circumstances as relationships, finances, and travel. The division of the twelve signs of the zodiac is based on the earth's year long rotation around the sun and relates to character aspects. For example, Venus represents affection, and Mercury represents speech and writing. Each planet rules two signs of the zodiac, while the sun and moon rule one sign each.

In approximately 2000 B.C., Babylonian astrologers believed that the sun, moon, and the five planets known at that time (Jupiter, Mars, Mercury, Saturn, and Venus) possessed distinct powers. Mars, for example, appeared to be red and was associated with aggression and war.

In the practice of astrology, a horoscope is a map of the zodiacal circle with the earth at the center. The top of the circle represents the sun at its highest point during the day. Left and right of the top of the circle are the eastern and western horizons respectively. A subject's horoscope charts the relative positions of the sun, moon, planets, and stars at a specific time and place of the subject's choosing, for example, the date, time, and location of the subject's birth. In measuring time, astrologers use “sidereal” time, which is measured from the equinox.

Once the date and time are selected and calculated as sidereal time, and the location known and plotted, the astrologer consults an emphemeris, or table listing the angles and locations of the sun, moon, planets, and constellations at any given time to construct the chart.

Interest in astrology has persisted throughout the centuries, occasionally falling out of favor, but always rebounding. Today, with practitioners in many countries, astrology's popularity is strong. Some regard astrology as superstitious nonsense without scientific basis. Others maintain that the symbolism of astrology can provide a deeper understanding of ourselves and of events. Still others use astrology for entertainment purposes.

Since astrology is now used by some purely for entertainment purposes, modern day astrological guidance may invoke the signs of the zodiac without necessarily being grounded in astrological sciences. Therefore, as used in this patent, astrological (i.e., horoscope based) guidance refers not only to guidance grounded in astrological science, but also to guidance that purports to be astrologically based, regardless of whether astrological principles were used to generate the guidance.

Like astrology, cosmetics have been used almost as long as there have been people to use them. Face painting is mentioned in the Old Testament (Ezekiel 23, v. 40), and eye shadow found in Egyptian burials dates back to 10,000 B.C. One of the early European cosmetics was woad, a blue paint used by the Picts and Celts for war paint and for personal decoration. Romanized Celts adopted the cosmetic practices of their conquerors, including face whitening with chalk and white lead, rubbing tartar from teeth with pumice, coloring fingernails with fat mixed with sheep's blood and bleaching the hair blond.

During the early Middle Ages, the dominance of the church kept the use of cosmetics to a minimum. Noble people who wished to achieve the fashionable pale complexion, applied white powder and water soluble paint or used leeches to drain the blood from their cheeks.

The pendulum swung, however, in the early 16th century. By that time, both ladies and gentlemen were moisturizing, powdering, painting and perfuming their skin constantly. Popular beauty treatments included rosemary water for the hair, elder flower ointment for the skin, sage to whiten teeth, bathing in wine, an egg white and honey mask to smooth away wrinkles, and geranium petal rouge.

Roman age Celts washed themselves often, sometimes spending hours at public baths. As this custom gradually faded, people's natural body odors became stronger until the introduction of perfumes by returning Crusaders in the 1400s was a welcome relief. Herb scents such as rosemary were popular, as well as myrrh, frankincense, orange, rose, and spice fragrances. Ladies, whose noses were believed to be far more delicate than men's, carried perfume filled pomanders to combat the stenches found in an occupied castle. The 17th century brought an explosion of cosmetic use, including extensive use of powder and rouge.

Today, both astrology cosmetics use are seen readily in day-to-day life. Cosmetics are a multibillion dollar business carried out in nearly every country of the world. Astrology is used by many for entertainment purposes, while other maintain that the symbolism of astrology can provide a deeper understanding of ourselves and of events. For whatever the purpose, both astrology and cosmetics enjoy widespread use.

### SUMMARY OF A FEW ASPECTS OF THE INVENTION

The present invention combines the age-old disciplines of astrology and cosmetics in a variety of unique ways. For example, using the invention, beauty advice may be dispensed as part of astrological guidance.

In one aspect, a method of providing guidance includes receiving profile information and information for identifying an astrological horoscope sign for a subject. The profile information may reflect at least one of physical attribute information and lifestyle information. Guidance may then be dispensed as a function of at least some of the profile information and the subject's astrological horoscope sign.

In another aspect, a method for providing guidance to a subject consistent with the invention includes establishing a set of criteria for classifying the subject in at least one of a plurality of predefined categories, the criteria including at least one of personal attribute information and lifestyle information. The subject may be advised of the category into which she falls, and guidance may be dispensed as a function of the astrological horoscope sign and the subject's predefined category.

In yet another aspect, a method of marketing beauty products consistent with the invention may include maintaining a first website offering for sale beauty products, and establishing a relationship between the first website and a second website dispensing astrological horoscope information. A user of the second website may then be provided with a recommendation to use a beauty product offered for sale through the first website, the recommendation being a function of the user's astrological horoscope sign. The linkage between the two sites may provide the user of the second website with an ability to purchase the recommended beauty product.

The foregoing is intended to inform the reader of only a few aspects of the invention. Moreover, it is to be understood that both the foregoing general description and the following detailed description are exemplary and explanatory only and are not intended to be restrictive of the invention as claimed.

### BRIEF DESCRIPTION OF THE DRAWINGS

The accompanying drawings, which are incorporated in and constitute a part of this specification, illustrate several embodiments and aspects of the invention and together with the description, serve to explain the principles of the invention.

FIG. 1 is a flow chart depicting a first exemplary method consistent with the present invention;

FIG. 2 is a first screen shot of an exemplary data entry page consistent with the present invention;

FIG. 3 is a first screen shot of an exemplary astrological horoscope sign receiving page consistent with the present invention;

FIG. 4 is a second screen shot of an exemplary astrological horoscope sign receiving page consistent with the present invention;

FIG. 5 is a schematic diagram of an exemplary operating environment in which the present invention may operate;

FIG. 6 is a schematic diagram of an exemplary guidance server depicted in FIG. 5;

FIG. 7 is a screen shot of an exemplary beauty guidance start page consistent with the present invention;

FIG. 8 is a screen shot of an exemplary login window consistent with the present invention;

FIG. 9 is a screen shot illustrating an exemplary confirmation page consistent with the present invention;

FIG. 10 is a screen shot of an exemplary guidance page consistent with the present invention;

FIG. 11 is a flow chart depicting a second exemplary method consistent with the present invention; and

FIG. 12 is a flow chart depicting a third exemplary method consistent with the present invention.

### DETAILED DESCRIPTION OF EXEMPLARY EMBODIMENTS

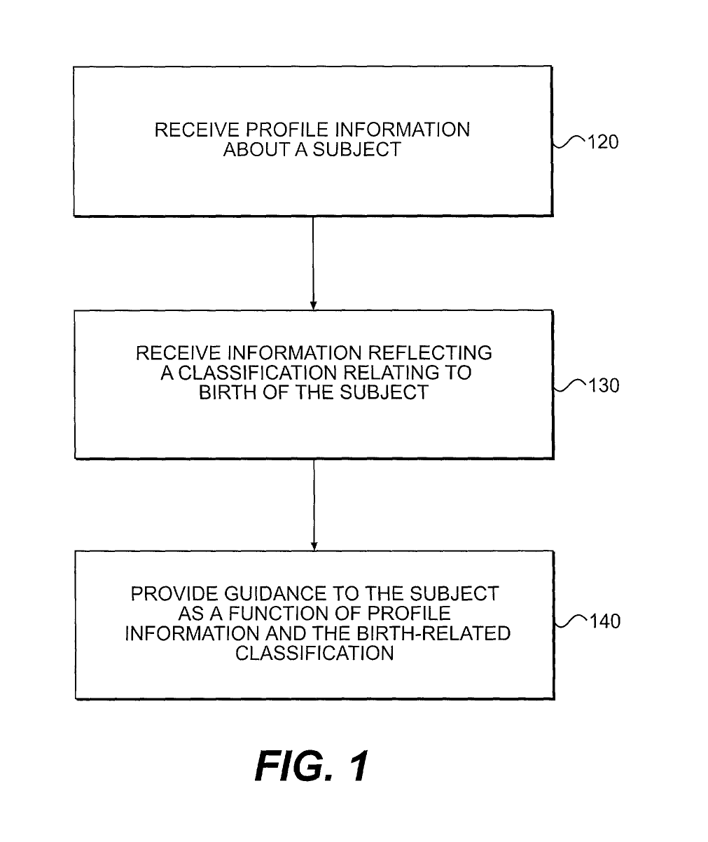

A guidance method consistent with the invention may include receiving profile information about a subject, the profile information reflecting at least one of physical attribute information and lifestyle information. Such a step is generally depicted at block 120 in the flow chart of FIG. 1.

Physical attribute information of the subject may include, but is not limited, to at least one of the following: skin tone, skin color, skin texture, level of wrinkles in the skin, skin pH level, hair style, hair color, length of hair, hair texture, curliness of hair, straightness of hair, hair pH level, eye color, eye size, eyebrow color, eyebrow thickness, eyelash length, nose type, nose size, lip size, lip tone, height, age, weight, birth date, facial features such as bone structure or facial shape, or any other information reflecting visual appearance of the subject.

Similarly, lifestyle information of the subject may include, but is not limited to, at least on of the following: vocation, hobbies, physical fitness level, eating habits, cosmetic usage habits, cosmetic preferences, apparel preferences, preferred colors, marital status, whether the subject is a parent, country of residence, region of residence, birth country and region, religious affiliation, political affiliation, whether the subject is an urban dweller, suburban dweller or rural area dweller, size of urban area in which the subject lives, whether the subject is retired, annual income, vacation preferences, citizenship and sexual preference, or any other information reflecting habits, preferences, or affiliations of the user.

Profile information may be received in one of many ways. For example, it may be received through Internet web pages, e-mail, diskette, CD ROM, DVD, facsimile, physical mail, an interactive voice response system (IVR), via voice over a publicly switched telephone network, or through any other mechanism for conveying information.

The profile information may be received in response to questions posed to a user or may be obtained in an indirect manner. Examples of indirect reception include tracking purchasing or browsing habits, tracking cookies, or collecting information about the user in any other manner that does not necessarily require the user to make an affirmative response. In addition, some or all of the profile information may be obtained by viewing the subject, by viewing an image of the subject, or by processing an image of the subject (using image processing techniques such as those described in concurrently filed applications incorporated herein by reference). Indeed, many of the physical attributes discussed earlier may be evident from such image observation.

If the invention is used in connection with the Internet, the profile information may be received via Internet web pages. This may occur through the use of a standard web browser type software package such as Microsoft Corporation's INTERNET EXPLORER™ or Netscape Communication Corporation's NAVIGATOR™ or COMMUNICATOR™ Internet browser computer programs. A user may access the Internet in a conventional manner such as through an Internet service provider (ISP).

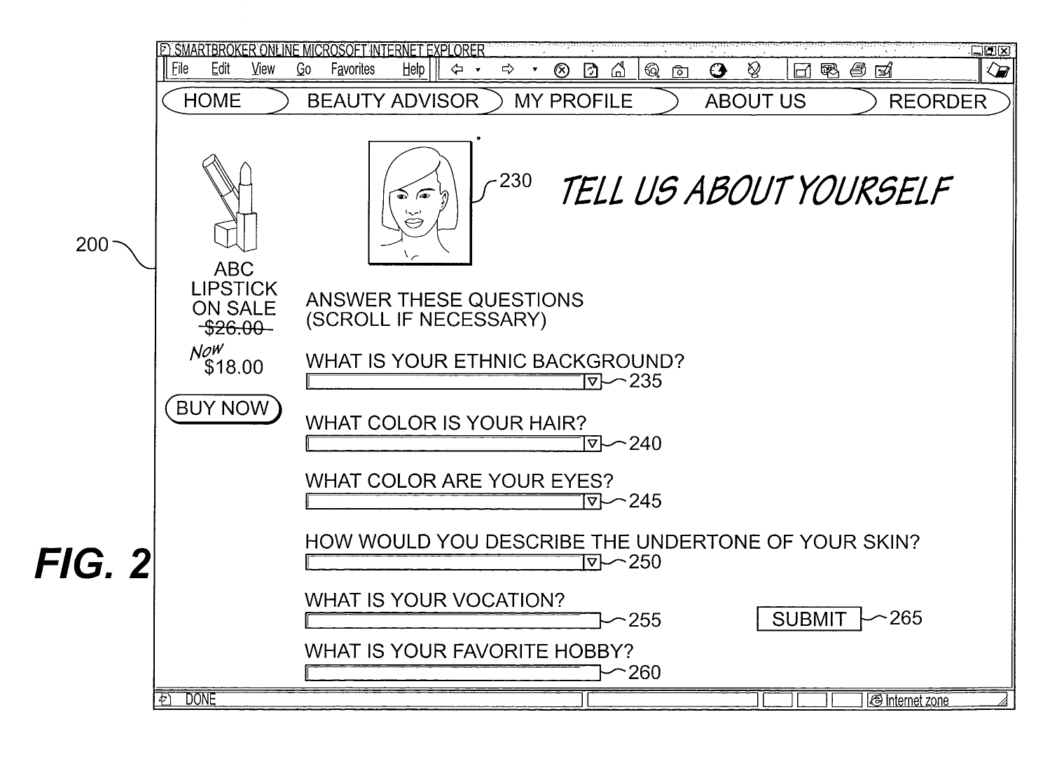

By way of example, profile information may be received through an Internet web page such as web page 200 in FIG. 2. Associated with exemplary questions about ethnic background, hair color, eye color, and skin tone, may be a series of drop-down selections lists 235, 240, 245 and 250, respectively. A user who clicks on the button associated with field 235 may view a pick list of ethnicities responsive to the question “What is your ethnic background?” Similarly, a user who clicks on buttons associated with drop-down selection lists 240, 245 and 250 may be able to scroll through a listing of colors responsive to the questions, “What is your hair color?”, “What color are your eyes?”, “How would you describe the undertone of your skin?”, respectively. As an alternative to, or an addition to drop-down selection lists, fields may be provided for free-form text entry. For example, free-form text fields 255 and 260 may enable a user to type lifestyle information about the subject's vocation and favorite hobby. Even when a drop-down list is provided, the user might have the option of entering information by typing words into the field.

While exemplary web page 200 contains questions seeking a few items of physical attribute information and lifestyle information, the web page might be configured to seek any combination of physical attribute information and lifestyle information previously discussed. Depending on the volume of information sought, multiple pages may be used to seek the information. In addition, the information may be sought through multiple channels. For example, an online questionnaire may be used in combination with other information gleaning tools previously described.

As is reflected in FIG. 2, the invention may (or may not) include an ability of the user to capture and display a self image 230. Image processing and capture techniques are described in concurrently filed applications, incorporated herein by reference. Those techniques might allow for simulated application of beauty products on the user's facial image.

A method consistent with the invention may include receiving information reflecting a classification relating to birth of the subject. This is reflected in block 130 in the flow chart of FIG. 1. By way of non-limiting example, birth-related classifications may include astrological horoscope signs, Karma, Numerology, Chinese and Indian zodiac signs, Charkas, other classifications based on birth day, birth month, birth year, birth place, or the way a planetary or other system was arranged when the subject was born. It may further involve new age classifications or abstractions, whether or not based on scientific principles, and whether or not the classifications currently exist. For example, the “constellations” of the Internet might serve as a basis for a new classification system. Thus, classifications could be based more on emotional, social, and psychological factors than on hard science.

This patent makes repeated reference to the astrological horoscope signs. However, it is to be understood that such discussions are for exemplary purposes only, and are not intended to be restrictive of the invention, as claimed. Thus, all characterizations related to astrological horoscope signs are equally applicable to any birth-related classifications, and the term “astrological horoscope sign” is used herein as a short-hand for all birth-related classifications.

As with all the flow charts presented herein, the order of blocks is not critical to the invention in its broadest sense. Thus, for example, the invention includes a method where block 130 precedes block 120.

Receipt of information reflecting a birth-related classification of the subject may occur through any mechanism—physical, electronic, or otherwise. For example, information may be provided by filling-out a hard copy form or questionnaire, physically mailing an indicator of the horoscope sign, or submitting an birth-related indicator through a communications network. The information may be received orally over a telephonic or other electronic communications network, may be received electronically through e-mail or web browser response, or may be received physically through a postal service or other courier.

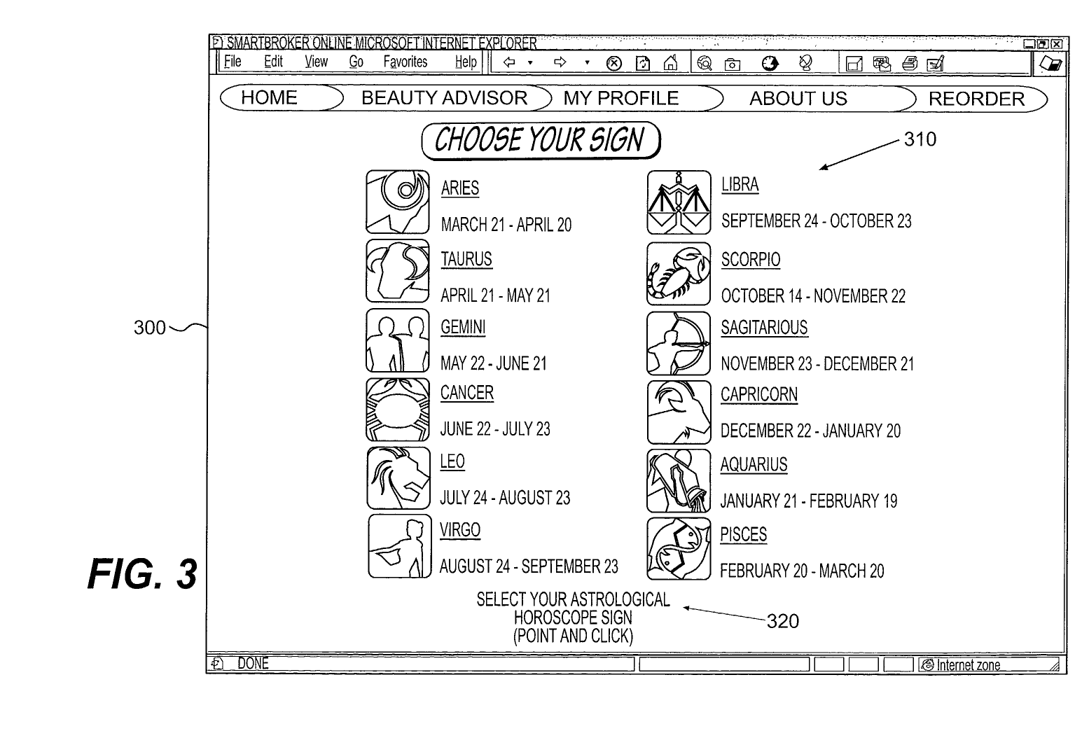

FIG. 3 is an exemplary screen shot of a web browser mechanism for submitting horoscope information. Exemplary web page 300 includes indications 310 of each of the zodiac signs. As is reflected in FIG. 3, the indications 310 may include one or more of an illustration or icon associated with each sign, the name of the sign, and the calendar days covered by the sign. Instructions 320 may be provided for directing a user to select an appropriate astrological horoscope sign. A user who clicks on one of the zodiac icons may cause the corresponding zodiac sign to be associated with the subject's record. By clicking on text associated with the sign, a user may be provided with information about that sign.

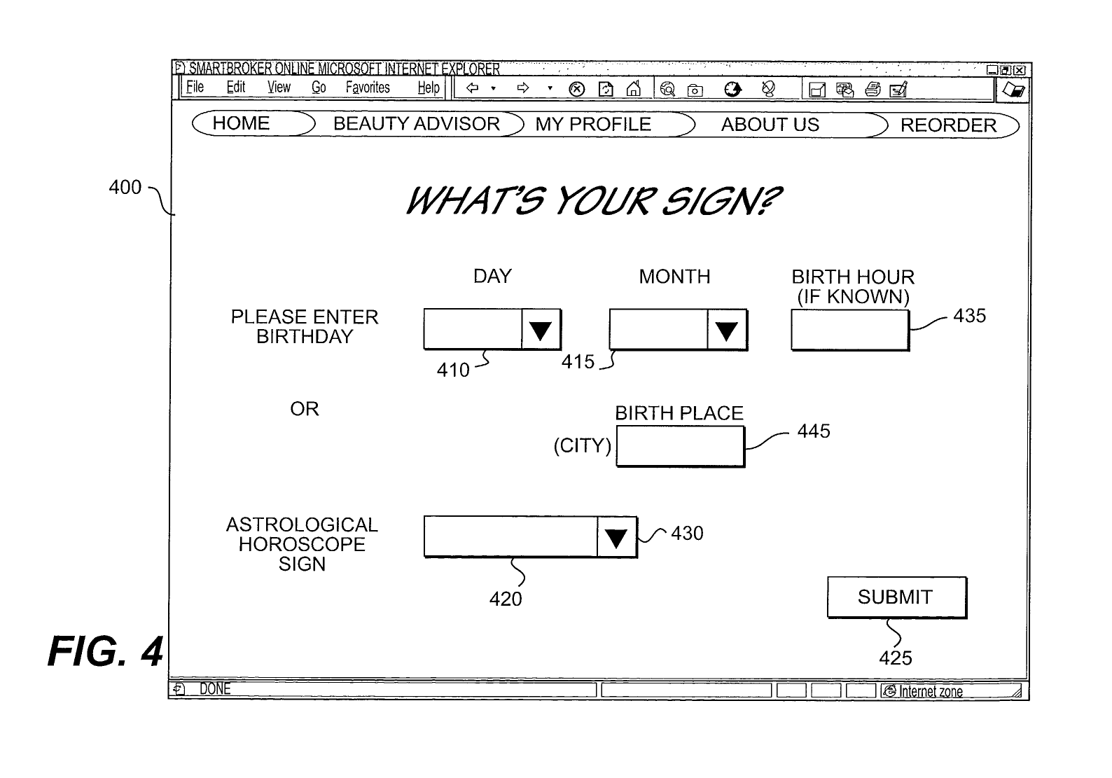

FIG. 4 illustrates an alternative web page for receiving information reflecting an astrological horoscope sign of the subject. In FIG. 4, web page 400 provides the user an option of entering a birth date in day and month fields 410 and 415, respectively. Thereafter, the appropriate astrological horoscope sign may appear automatically in field 420.

Alternatively, if the user already knows her astrological horoscope sign, she may type it in field 420 or may activate button 430 for a drop-down pick list of astrological horoscope signs. Upon selecting an appropriate sign, it may automatically appear in field 420.

Certain classifications may make use of more detailed birth-related information. Thus, depending on embodiment, additional fields, such as fields 435 and 445 might be provided to respectively gather information about the subject's birth hour and birth place (city). After the user has completed entering data, the data may be associated with the subject's record by activating submit button 425.

A method consistent with the present invention may further include providing guidance for the subject, the guidance at least including beauty advice and being a function of at least some of the profile information and the subject's birth-related classification. This step is reflected by block 140 in FIG. 1. Guidance is defined herein as including advice, predictions, or any other information intended to aid a subject in a course of future conduct, to aid a subject in understanding past occurrences, or to reflect information about some future occurrences.

Guidance may be provided to the subject one of many ways. Thus, the invention, in its broadest sense, is not limited to any particular mechanism or form of guidance. For example, physical or electronic look-up tables may be maintained, that correlate specific guidance with combinations of profile information and astrological horoscope signs. So, for example, a table may include a particular piece of guidance for individuals who identify themselves as falling under the Capricorn zodiac sign, living in New York City, having dark hair, fair skin, brown eyes and being of an age under 40.

The look-up table may be configured so that the same piece of guidance may correlate to multiple combinations of profile information and horoscope signs. Alternatively, a relatively limited number of categories of profile information may be contained in the look-up table, and a separate piece of guidance may exist for each combination of birth-related classification and profile information. Look-up tables may change periodically. For example, a new look-up table may be used on a daily, weekly or monthly basis so that the provided guidance is always changing.

Depending on any one of a number of factors, including the current date, different weightings may be placed on different elements of profile information. For example, on a particular day, a combination of eye color and zodiac sign might be the only determining factor in selecting guidance from the look-up table. Alternatively, weightings may be assigned to various elements of profile information, and based on those weightings (e.g., through a cumulative score) guidance may be ascertained from the look-up table. It is to be understood that a virtually infinite number of algorithms may be constructed for correlating elements of personal information with guidance on a look-up table. Therefore, the invention, in its broadest sense, is not limited to any particular algorithm.

Indeed, other algorithms need not necessarily require a look-up table. For example, artificial intelligence engines may be used to select guidance based on a host of provided items of personal information. Artificial intelligence searching techniques are known to persons of ordinary skill in the art. They are generally described in concurrently filed applications, incorporated herein by reference.

The provided guidance may be based in part on data stored on a specific subject, on data stored on other individuals with similar profile information, or upon analyzing the profile data of the subject at hand. For example, an artificial intelligence engine may correlate the profile information of the subject with a database containing a plurality of pre-defined beauty advice records. The correlation may be based upon past success with other individuals sharing similar profile information. The artificial intelligence engine may analyze a database to find a previously stored profile that best matches the profile information of the subject at hand. Once the match is identified, advice believed to be proven effective for an individual with similar traits may be dispensed to the subject in the form of guidance.

Also, the profile information may be analyzed, and beauty advice may be provided based upon a predefined set of rules. For example, given specific profile information that determines a particular skin type, a particular makeup foundation may be suggested as part of the provided guidance. Likewise, for the determined skin type, the provided guidance might expressly suggest not to use a particular category or color of makeup. In another example, the guidance may be a function of at least one of a demographic location of the subject, and an environmental condition at the subject's demographic location such as the current weather conditions, and predicted weather conditions.

The guidance may be provided in one or more of many forms. For example, the guidance may include a recommendation to use a particular beauty product that may be offered for sale to the subject. The guidance may also include information as to a price and availability of the beauty product as well as a suggestion as to where it can be purchased. The suggestion as to where it can be purchased may be based on demographical information provided by the user. In addition, if the guidance is provided via e-mail or via a web page, the guidance may include a hyperlink to a website or web page where the product may be purchased. Furthermore, websites where the product may be purchased may be provided with the ability to accept orders and corresponding payments for products offered for sale on the website.

Guidance may include a suggestion to use products not only of a particular brand, but also of a particular line of products within a particular brand. For example, the subject may specify a preference for a particular brand of cosmetic or may further specify which line, if any, within the particular brand the subject prefers. Similarly, the subject may specify certain brands or lines the subject does not prefer. In addition, particular beauty products may be suggested and included in the guidance based at least in part on which brands or lines are overstocked or for which there is some other desire to move from inventory.

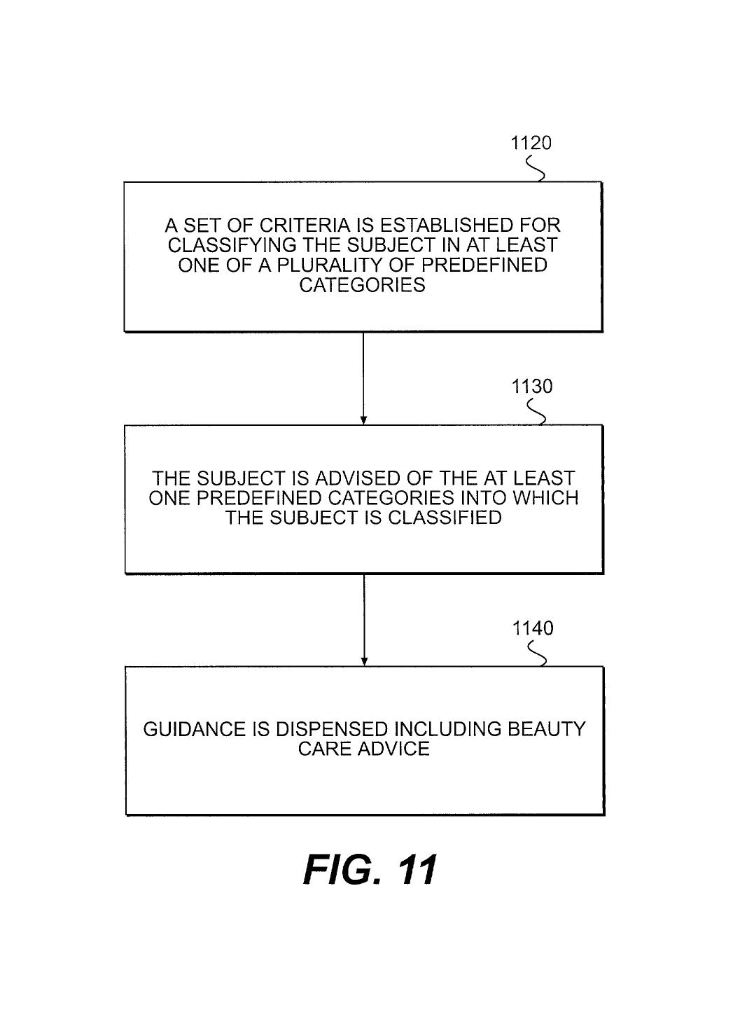

In one embodiment of the invention, the profile information may be used to categorize the subject into at least one of a plurality of predefined categories. FIG. 11 is a flow chart setting forth such an example. At block 1120, a set of criteria is established for classifying the subject in at least one of a plurality of predefined categories, the criteria including at least one of personal attribute information and lifestyle information. For example, the plurality of categories may include exemplary names such as: Earth, Fire, Wind, Rain, Ice and Sky. Based upon certain characteristics within the profile information, the subject may be placed in one of the plurality of categories. By way of example, a person may be placed in a category based on a combination of criteria such as ethnicity, hair color, skin tone, and age.

Subsequently, the guidance may be provided as a function of the predefined category to which the subject belongs and the birth-related classification (e.g., astrological horoscope sign) of the subject. For example, a particular type of advice may be given to a Gemini Wind, another type of advice may be given to a Virgo Ice and yet another type of advice may be given to a Taurus Fire. In addition, the plurality of predefined categories may be organized as subcategories beneath astrological signs or they may be organized independent of astrological signs. For example, Pisces may be subdivided into Pisces Earth, Pisces Fire, Pisces Wind, Pisces Rain, Pisces Ice and Pisces Sky, and Libra may be subdivided into Libra Earth, Libra Fire, Libra Wind, Libra Rain, Libra Ice and Libra Sky. In this situation, Libra Fire and Pisces Fire may receive differing advice. In contrast, all Fires may get the same advice or subset of advice on a given day if the plurality of categories are organized independent of astrological signs. These criteria and predefined categories are exemplary, and persons of ordinary skill in the art will appreciate that many other types and combinations of criteria and predefined categories may be employed.

At block 1130 of FIG. 11, the subject may be advised of the at least one predefined categories into which the subject is classified. This communication may occur, for example, via web pages, via e-mail, or with any other communication mechanism as described above.

At block 1140, guidance may be dispended including beauty advice. As reflected in FIG. 11, the guidance may be a function of at least one predefined category into which the subject is classified. Again, the guidance may be dispensed through any communication mechanism, at a regular or irregular intervals. For example, once a week a newspaper may contain guidance information for each of an astrological horoscope and predefined category pair. This information can be a regular feature of the newspaper or may be contained in a paid advertisement. The guidance may be dispensed daily or weekly to an e-mail address after all pertinent information relevant to the subject at the e-mail address has been obtained. Furthermore, the information could be a regular feature within a certain station's radio or television programming.

Moreover, the plurality of predefined categories may be organized as subcategories beneath astrological horoscope signs or they may be organized independent of astrological horoscope signs. For example, Pisces may be subdivided into Pisces Earth, Pisces Fire, Pisces Wind, Pisces Rain, Pisces Ice and Pisces Sky, and Libra may be subdivided into Libra Earth, Libra Fire, Libra Wind, Libra Rain, Libra Ice and Libra Sky. In this situation, Libra Fire and Pisces Fire may get different advice. In contrast, all Fires may get the same advice on a given day if the plurality of categories are organized independent of astrological signs.

The beauty advice may include information on how to apply at least one beauty product. For example, the advice may not only include a suggestion to use a particular beauty product, but may also include suggests on how the product is best used or applied. This information may also include alterative uses or application methods.

The beauty guidance may include information on how to apply at least one beauty product. For example, the advice may not only include a suggestion to use a particular beauty product, but may also include suggests on how the product is best used or applied. This information may also include alterative uses or application methods. For example, the guidance may suggest a certain type of eye shadow, and then further include directions on its application together with suggestions on types of eye liners and eye liner shades that best complement the suggested eye shadow.

The guidance provided to the subject may include providing at least one prediction identified as being based on the birth-related classification. This birth-related classification prediction (e.g., astrologically-based prediction) may include a recommendation to use at least one beauty product that may bear a preferred brand name pre-identified by the subject or a preferred line within a brand name pre-identified by the subject. The beauty advice may be integrated into the astrologically based prediction or may be presented independent of the astrologically based prediction. For example, the guidance may include a suggestion to “wear ruby red brand-x lipstick number 4 and you will have a successful day.” Or, for example, the guidance may suggest that the subject “Wear ruby red brand-x lipstick number 4. Today you will be successful.”

The prediction identified as being astrologically based may be either fully or partially grounded in the rules of astrological science. Furthermore, the prediction identified as being astrologically based may merely be a prediction that gives the appearance of what people traditionally perceive as being an astrological prediction with no actual basis in the rules of astrological science. Thus the prediction identified as being astrologically based may have actual scientific significances to those who adhere to the science of astrology or may offer value as entertainment to others.

The astrological prediction may include a suggestion that a course of future events may change based on use of certain beauty products, may correlate a use of at least one specified beauty product with a predicted future occurrence, or may correlate a failure to use at least one specified beauty product with a predicted future occurrence. For example the guidance may suggest that “you are likely to miss an important opportunity today, however, if you wear ruby red brand-x lipstick number 4, the missed opportunity may be avoided”; or “wearing ruby red brand-x lipstick number 4 will help you capture an important opportunity today”; or “if you don't wear ruby red brand-x lipstick number 4 you are likely to miss an important opportunity today”.

Furthermore, the guidance may include advice suggesting the subject purchase and have on hand a certain beauty product because it will be needed in conjunction with guidance to be provided in the future. For example, the guidance may suggest that “sometime next week, your horoscope will suggest that you wear ruby red brand-x lipstick number 4 to help you seize an opportunity you will not want to miss. If you don't already own ruby red brand-x lipstick number 4, now would be a good time to purchase it.” A “buy now” button may then enable the subject to immediately make an e-commerce purchase, perhaps with some sort of incentive such as a discount or free shipping.

Alternatively, providing guidance may include providing the subject with at least one birth-related classification prediction, and thereafter providing beauty advise in response to a request by the subject. For example, the guidance on a web page may include “To be successful today, Taurus must look her best”. The web page may include a button, which when clicked, presents suggestions on how Taurus can look her best, including beauty advice suggesting particular beauty products, their best use, and how they can be purchased.

The guidance may be automatically provided on a periodic basis. This may be performed by storing at least some of the received profile information, information reflecting the astrological sign of the subject, and an address of the subject, and periodically providing guidance to the subject through the subject's stored address. If the stored address is an e-mail address, the guidance, including, for example, an astrological horoscope prediction, information about a beauty product, and/or information about how to purchase the beauty product, may be sent to the subject's e-mail address. Alternatively, the guidance may be transmitted to the subject through other electronic means or through physical delivery.

To provide birth-related classification information (e.g., astrological horoscope information), an association between a beauty product supplier and a provider of horoscope information may be established such that when user 502 accesses a website of a beauty product supplier, information of the astrological horoscope information provider is presented to the subject. For example, in providing the guidance to user 502 via web pages controlled, for example, by guidance server 515, a hyperlink to information of the astrological horoscope information provider (or other provider of birth-related classification information) may be displayed on a web page provided to user 502. When clicked, this hyperlink may cause the web browser of user device 505 to display web pages containing astrological horoscope information. These web pages containing astrological horoscope information may be controlled by an astrological horoscope server 575 operated under the direction of the astrological horoscope information provider.

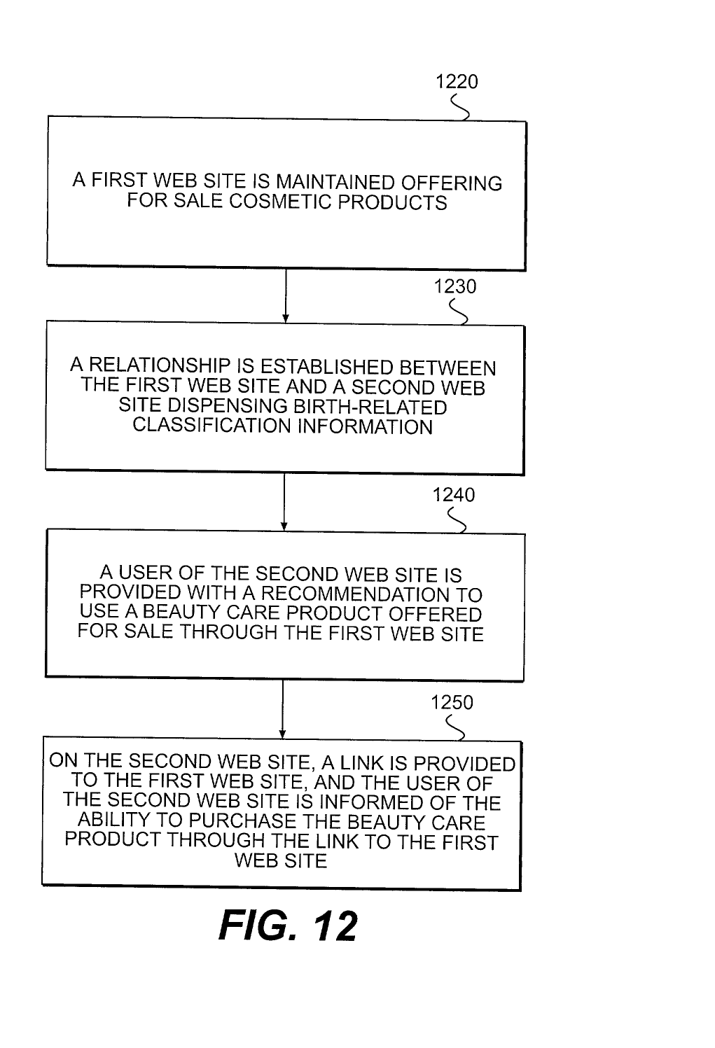

FIG. 12 is a flow chart setting forth the general stages involved in an exemplary beauty marketing method. At block 1220, a first website is maintained, offering for sale beauty products. This may be accomplished using a conventional Internet sales portal.

At block 1230, a relationship is established between the first website and a second website dispensing birth-related classification information. For example, Lancôme might establish a relationship with an on-line horoscope website, and the sites might be hyperlinked together.

At block 1240, a user of the second website is provided with a recommendation to use a beauty product offered for sale through the first website, the recommendation being a function of the user's astrological horoscope sign. Thus, for example, the horoscope website might make a recommendation for a product sold on Lancôme's website.

As reflected in block 1250, a link from the first website is established such that the user of the second website is informed of the ability to purchase the recommended beauty product through the first website. This may be accomplished through a hyperlink button, for example.

Of course, in a similar manner, a user might initiate a browsing session at a cosmetic website, and be provided with information from a horoscope website through a hyperlink button or through an automatic transfer of information. These examples contrast with earlier presented examples where beauty information and horoscope information may both originate at a single website.

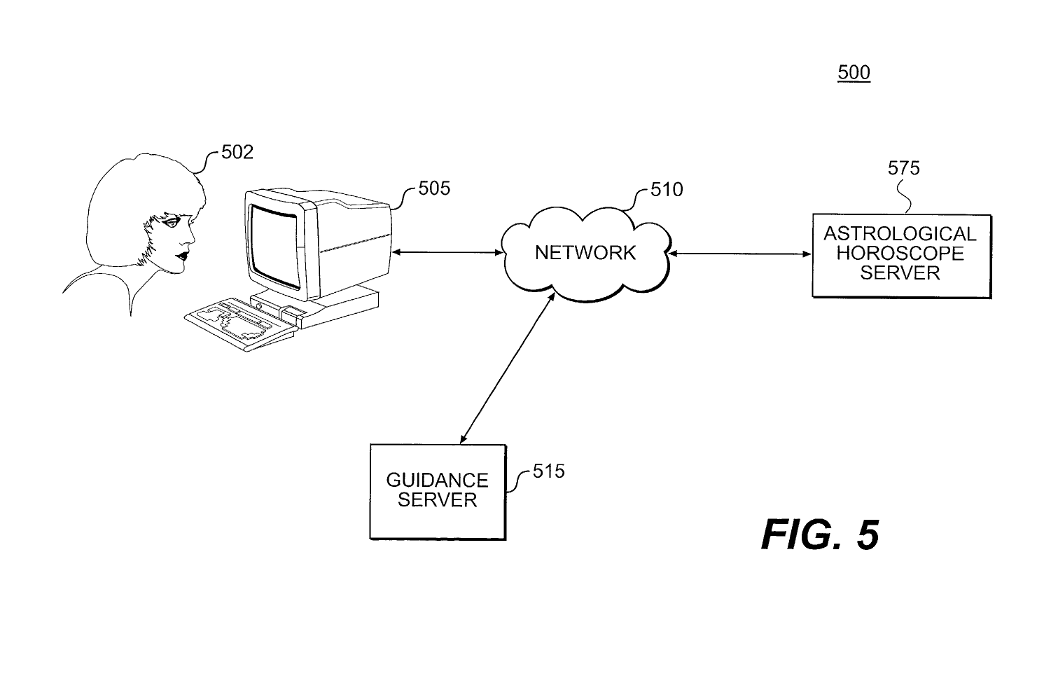

As illustrated in FIG. 5, an exemplary guidance providing system 500 may include a network 510, a user device 505 on a client side of the network, and a guidance server 515 on a server side of the network. In the exemplary embodiment of FIG. 5, the component for receiving profile information, the component for receiving information reflecting an astrological horoscope sign, and the component for providing guidance may all be embodied in guidance server 515. Alternatively, one or more of those elements could be provided as separate components.

User device 505 may include a personal computer, a hand-held computing device, a multiprocessor system, microprocessor-based or programmable consumer electronic device, a minicomputer, a mainframe computer, a personal digital assistant (PDA), a mobile phone, a facsimile machine, a telephone, a pager, a portable computer, or any other device for receiving and/or transmitting information.

User device 505 may be practiced in distributed computing environments where tasks are performed by remote processing devices. If user device 505 includes a mobile terminal such as a smart phone, a cellular telephone, a cellular telephone protocols such as wireless application protocol (WAP), or bluetooth protocol may be utilized. Such mobile systems might also be configured to permit the user to purchase products through a browser on a display of the mobile device.

The invention in its broadest sense is not limited to a particular form of user device or communications protocol. And those of ordinary skill in the art will recognize that other systems and components may be utilized with the scope and spirit of the invention.

User device 505 may be located for example, in a home, office, store, cosmetic counter within a store, kiosk, salon, spa, other beauty facility, sales location, or, in the case of a mobile device, in a vehicle or on the person of the user. Moreover, the user 502 of user device 505 may be a subject receiving the guidance, a technician, a cosmetic advisor, a sales consultant, a sales person, or any other entity. The invention, in a broader sense, is not limited for use by a particular individual in a particular location. Rather, it should be appreciated that user device 505 may be located at a variety of places and operated by a variety of people within the scope and spirit of the invention.

Network 510 may include, for example, a local area network (LAN) or a wide area network (WAN). Such networking environments are commonplace in offices, enterprise-wide computer networks, intranets, and the Internet, and are known by those of ordinary skill in the art. When a LAN is used as network 510, user device 505 and elements of guidance server 515 may be connected to network 510 through a network interface located at each of the respective user device 505 and elements of guidance server 515. When a WAN networking environment is utilized as network 510, user device 505 and elements of guidance server 515 typically may include an internal or external modem (not shown) or other means for establishing communications over the WAN.

In addition to utilizing a wire line communications system as network 510, a wireless communications system, or a combination of wire line and wireless may be utilized as network 510 in order to, for example, exchange web pages via the internet, exchange e-mails via the Internet, or to utilize other communications channels. Wireless communications may include radio transmission via the airwaves, however, those of ordinary skill in the art will appreciate that various other communication techniques can be used to provide wireless transmission including infrared line of sight, cellular, microwave, satellite, blue-tooth packet radio and spread spectrum radio. Wireless data may include, but is not limited to, paging, text messaging, e-mail, Internet access and other specialized data applications specifically excluding or including voice transmission. In its broadest sense, network 510 may include mechanisms for facilitating communications between two nodes or remote locations.

Data sent over network 510 may be encrypted to insure data security. When encrypting, the data may be converted into a secret code for transmission over a public network. The original file, or “plaintext,” may be converted into a coded equivalent called “ciphertext” via an encryption algorithm executed, for example, on user device 505 or on elements of guidance server 515. The ciphertext may be decoded (decrypted) at a receiving end and turned back into plaintext.

Public key cryptography software such as distributed under the name Pretty Good Privacy (PGP) from Pretty Good Privacy, Inc., of San Mateo, Calif., (www.pgp.com) may be utilized in this embodiment. While PGP may be used to encrypt data transmitted over network 510, those of ordinary skill in the art will appreciate that many other types of encryption algorithms, methods, and schemes may be employed within the scope and spirit of the invention. Alternatively, the invention may be practiced without any form of privacy security.

In guidance providing system 500, data may be transmitted by methods and processes other than, or in combination with network 510. These methods and processes may include, but are not limited to, transferring data via, diskette, CD ROM, facsimile, conventional mail, an interactive voice response system (IVR), or via voice over a publicly switched telephone network. An IVR is an automated telephone answering system that responds with a voice menu and allows the user to make choices and enter information via the telephone keypad. IVR systems are widely used in call centers as well as a replacement for human switchboard operators. An IVR system may also integrate database access and fax response.

Other servers, such as an astrological horoscope server 575, may be included in guidance providing system 500. Other servers used in guidance providing system 500 may be constructed in an architecture similar to guidance server 515 or may be constructed using other suitable architectures as are known by those of ordinary skill in the art. Although illustrated as separate units, it should be understood that guidance server 515 and horoscope server 575 may be integrated into a single unit.

In providing astrological horoscope information, an association between a beauty product supplier and a provider of astrological horoscope information may be established such that when user 502 accesses a website of a beauty product supplier, information of the astrological horoscope information provider is presented to the subject. For example, in providing the guidance to user 502 via web pages controlled, for example, by guidance server 515, a hyperlink to information of the astrological horoscope information provider may be displayed on a web page provided to user 502. When clicked, this hyperlink may cause the web browser of user device 505 to display web pages containing astrological horoscope information. These web pages containing astrological horoscope information may be controlled by astrological horoscope server 575, operated under the direction of the astrological horoscope information provider.

In addition to receiving the profile information about the subject via Internet web pages, the profile information may be received via e-mail. In this situation, software modules located on user device 505 can question user 502, extracting the profile information similar to the manner in which the same information was extracted using web pages, as described above.

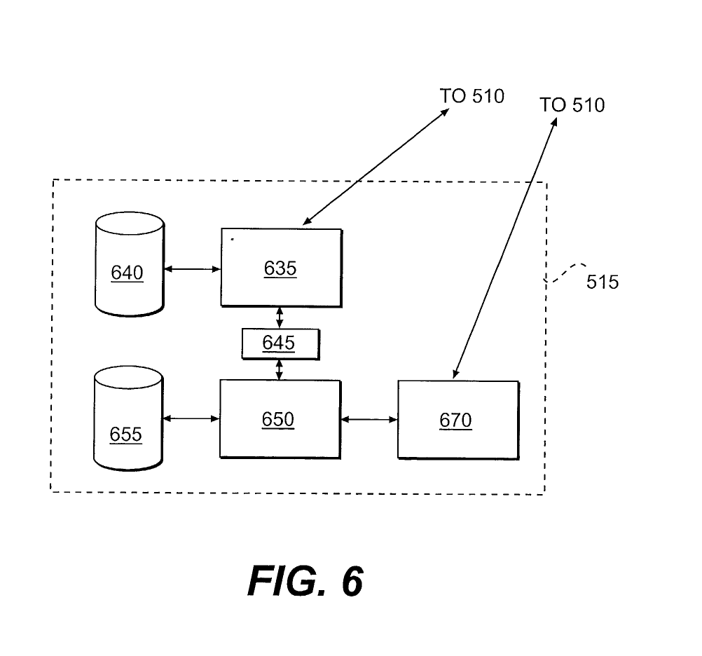

Referring to FIG. 6, exemplary guidance server 515 may include a first server front end 635 with its associated first server front end database 640, a first server back end 650 with its associated first server back end database 655, and a simple mail transfer protocol (SMTP) server 670. Those of ordinary skill in the art will appreciate that this particular architecture of guidance server 515 is exemplary, and that many other types of systems or architectures may be employed to implement guidance server 515.

In exemplary guidance server 515 of FIG. 6, first server front end 635 may be separated from first server back end 650 by a first server firewall 645. One function of first server front end 635 may be to provide an interface via network 510 between user device 505 and guidance server 515. The function of the SMTP server 670 may be to provide, for example, an e-mail interface via network 510 between user device 505 and first server 515. If profile information is received via e-mail, the e-mail may then be sent through network 510 to SMTP server 670. SMTP server 670 in turn may send the data to first server back end 650. First server back end 650 may then store the data in first server back end database 655.

As with the reception of the profile information in stage 120 of FIG. 1, other methods, processes, or devices besides the Internet or e-mail may be used to provide guidance to the subject. These other methods, processes, or devices may include, but are not limited to, transferring data containing the guidance via diskette, CD ROM, facsimile, conventional mail, an interactive voice response system (IVR), or via voice over a publicly switched telephone network.

If a user requests automatic guidance on a periodic basis, the user might be prompted to provide an address to which the guidance is to be sent. If the address provided is for a mobile receiver/transmitter, an astrological horoscope prediction, information about a beauty product, and information about how to purchase the beauty product may be sent to the subject's mobile address via the mobile receiver.

First server front end 635 and first Server back end 650 may comprise a personal computer or other similar microcomputer-based workstations. Those skilled in the art, however, will appreciate that first server front end 635 and first Server back end 650 may comprise any type of computer operating environment such as hand-held devices, multiprocessor systems, microprocessor-based or programmable consumer electronics, minicomputers, mainframe computers, and the like. First server front end 635 and first server back end 650 may also be practiced in distributed computing environments where tasks are performed by remote processing devices. By way of example only, first server front end 635 may be implemented on a COMPAQ PROLIANT 1600 server running WINDOWS 2000 and DOMINO Webserver. First Server back end 650 may be implemented on a COMPAQ PROLIANT 1600 server running NT4 and DOMINO Application Server. And SMTP server 670 may be implemented on a COMPAQ DL 360 running WINDOWS 2000 and DOMINO SMTP Mail Server.

As stated previously with respect to stage 120 of FIG. 1, profile information may be received via web pages. Once user 502 has connected to the Internet through user device 505, user 502 may point the web browser to the Internet home page address or Uniform Resource Locator (URL) of first server front end 635. One function of first server front end 635 may be to provide an Internet interface between user device 505 and first server 630. It may receive hypertext transfer protocol (http) requests from a web browser computer program directed to a specific URL, and provides responses to the requesting computer system that, when processed by the web browser computer program, displays a page of the Internet website associated with the URL. An exemplary URL employed by the present invention might be “http://www.ABCcosmeticquidance.com”. Directing an Internet-connected computer system with an operative Internet web browser program at this URL may cause a display of the home page associated with this website on the computer's display. Such operations are well known to those of ordinary skill in the art and will not be discussed further herein.

The site corresponding to http://www.ABCcosmeticquidance.com may be coded in hyper text mark-up language (HTML) and use a Secure Sockets Layer (SSL) certificate for added protection and encryption during request transmission.

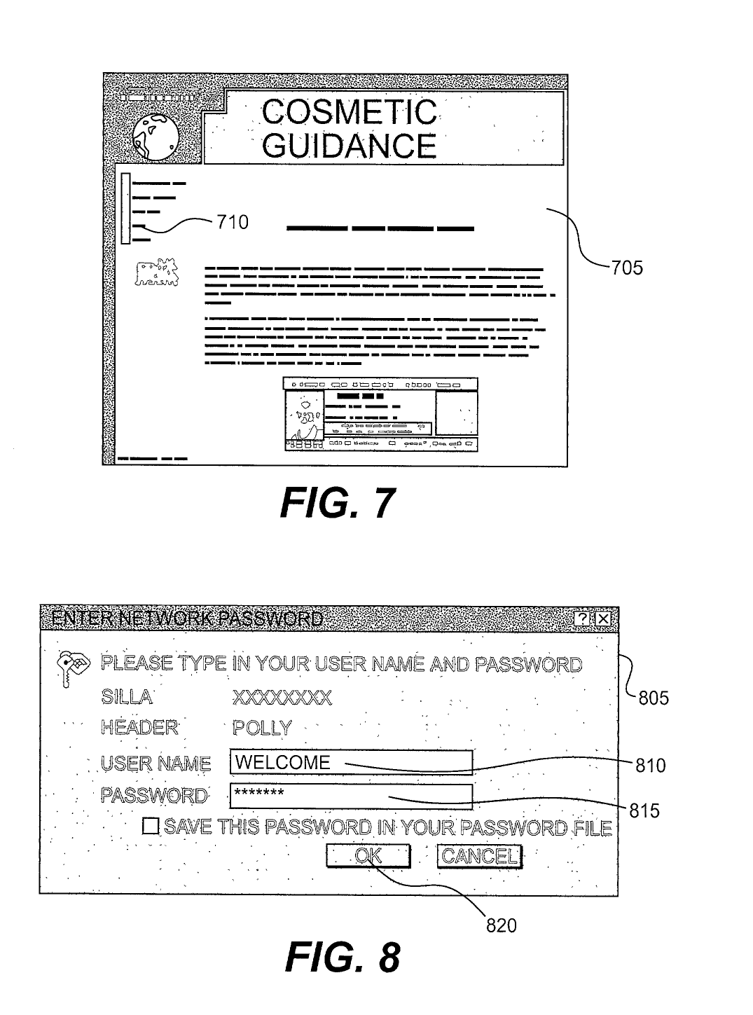

After user 502 points the web browser to the Internet home page address of the beauty guidance start page 705 at www.ABCcosmeticquidance.com as shown in FIG. 7, user 502 may log into first server front end 635. To initiate the login process, user 502 may click a login button 710 of FIG. 7. Once login button 710 is clicked, a login window 805 may appear as shown in FIG. 8. At login window 805, user 502 may enter a unique username 810, and password 815 combination, and click an “OK” button 820 in order to obtain access to web page 200 as shown in FIG. 2. Alternatively, access may be automatic, such as through a cookie. Web page 200 (FIG. 2) may reside on first server front end 635 existing outside of first server firewall 645.

Once user 502 logs into first server front end 635, user 502 may enter profile information and, in an alternative embodiment of the invention, may designate an image file of the subject for uploading as is discussed later.

After entering profile information in the designated fields on web page 200, user 502 may initiate the data transmission by clicking a submit button 265 of FIG. 2. Clicking submit button 565 may trigger a temporary record save to first server front end database 640 on first server front end 635. Data included in this temporary record save may include data corresponding to the profile information in the designated fields of web page 200. After the temporary record save to first server front end database 640 is completed, data corresponding to the profile information may be transferred through firewall 645 to first server back end database 655 located on first server back end 650. This transfer may be initiated after proper data security and validation processes are performed as are know by those of ordinary skill in the art.

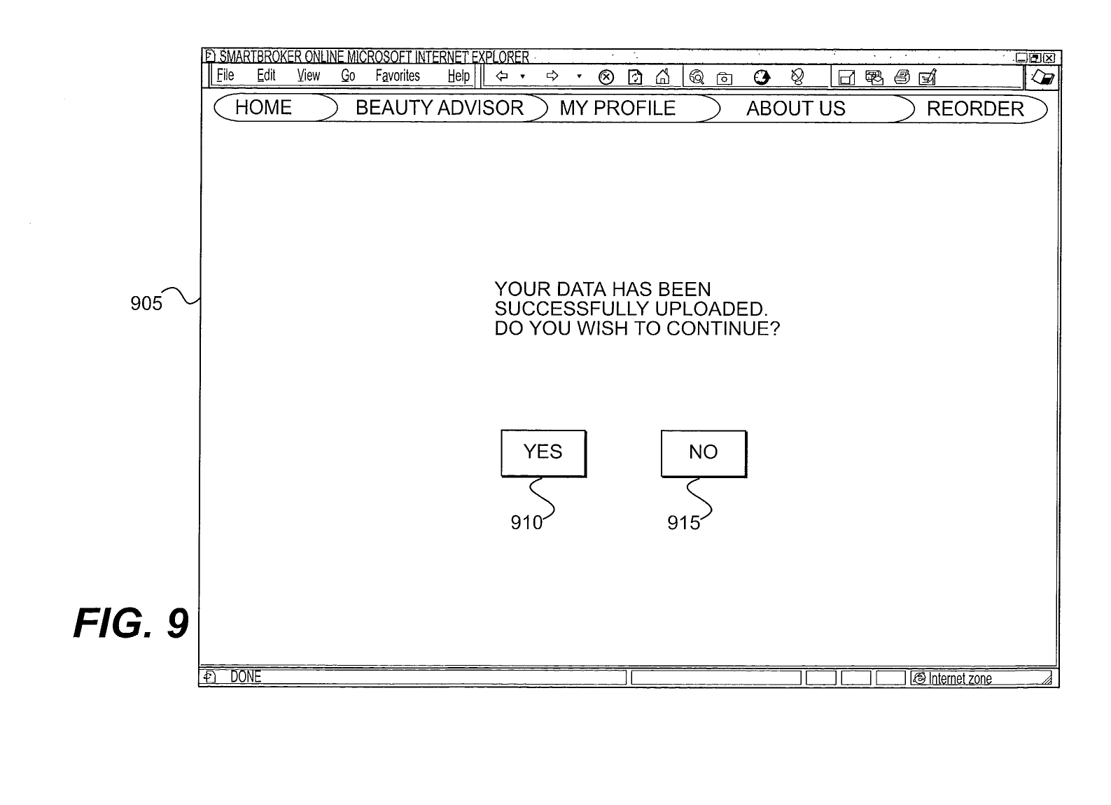

When user 502 clicks the submit button 265, a confirmation page 905 as shown in FIG. 9 may be displayed after the temporary record is successfully saved to first server front end database 640. If user 502 wishes to continue, a yes button 910 may be clicked. If user 502 does not wish to continue, a no button 915 may be clicked.

If data corresponding to the profile information is transferred via diskette or CD ROM, user device 505 may be utilized to gather the data. This data may be gathered by executing a programming module within user device 505 that interrogates the user with questions, and gathers the data containing the profile information from the interrogation onto a media such as a diskette, CD ROM, or other media usable by user device 505. Once this data is gathered onto the media, the media with its corresponding data may be transferred to guidance server 515 in any conventional manner.

As an alternative, the interrogation may occur by presenting the subject with questions in verbal or written format. Once a verbal or written interrogation is complete, the data gather may then be transferred to user device 505, and in turn transferred to a media such as a diskette, CD ROM, or other media usable by user device 505.

If an IVR is utilized in guidance providing system 500, the user or subject may be interrogated by the IVR, which in turn may transfer the data gather in the interrogation to guidance server 515. Similarly, a service representative, remote or local to the subject may verbally interrogate the subject via a publicly switched telephone network, and then transfer the profile data obtained in the interrogation to the guidance server 515.

From block 120 of FIG. 1 where profile information about the subject is received, the method continues to block 130 where information reflecting an astrological horoscope sign of the subject is received. As with the reception of the profile information in block 120, other methods, processes, or devices besides the Internet may be used to receive information reflecting an astrological horoscope sign of the subject. These other methods, processes, or devices may include, but are not limited to, transferring data via the various media discussed earlier.

Guidance may be generated by programming modules located and executed on first server back end 650, analyzing data including, for example, the profile data, information reflecting the astrological horoscope sign of the subject, image data of the subject, or other data.

In addition, an identification code of the subject can be stored so that user 502 is enabled to receive selective guidance using the identification code. Specifically, after the initial reception of the profile information, the profile information may be stored in a manner associating it with a particular subject with a particular identification code. In this way, the profile data will not have to be reentered the next time the subject seeks guidance. Moreover, patterns corresponding to the subject may be established and recorded to better serve the subject with subsequent guidance.

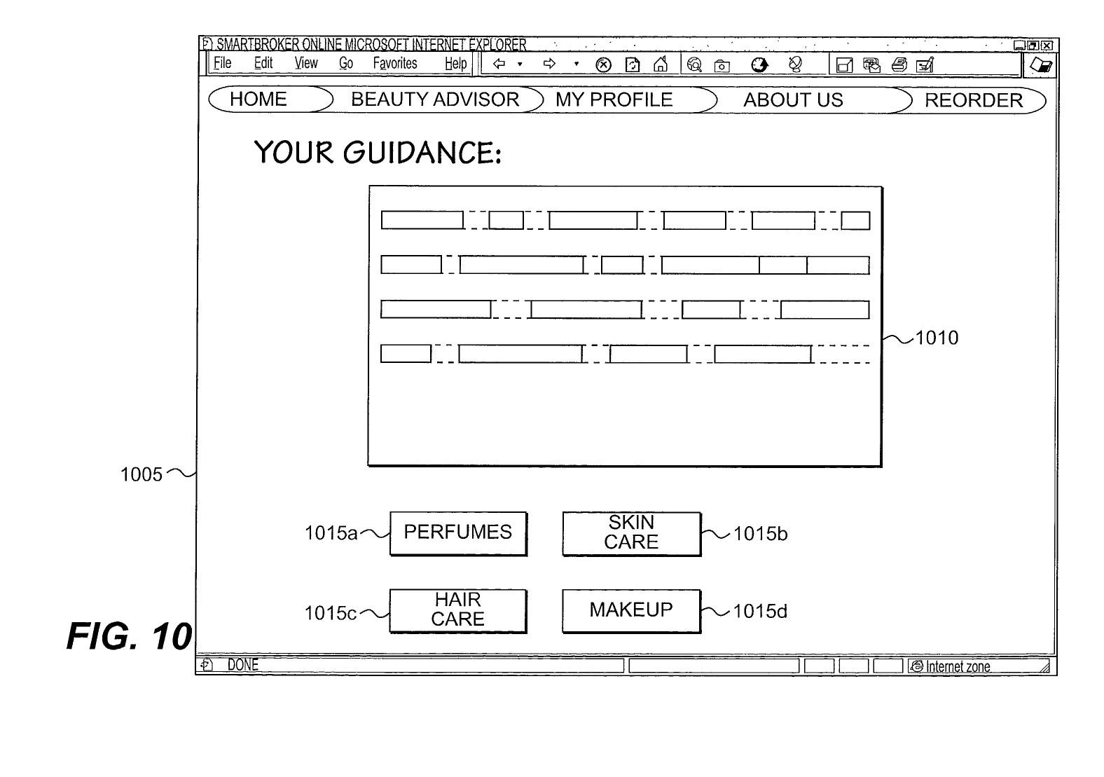

The guidance may be provided to the subject, for example, in guidance page 1005 of FIG. 10. As shown in FIG. 10, the guidance may be provided in guidance section 1010. Buttons 1015a-1015d may provide hyperlinks to pages where product suggested in the guidance section 1010 may be purchased. Specifically, button 1015a may provide a link to where perfumes may be purchased, button 1015b may provide a link to where skincare products may be purchased, button 1015c may provide a link to where hair care products may be purchased, and button 1015d may provide a link to where makeup products may be purchased. The aforementioned hyperlink buttons 1015a-1015d are exemplary, and those skilled in the art will appreciate that many other types of hyperlink buttons may be utilized. Alternatively, the invention may not include hyperlink buttons.

In providing the guidance via e-mail, the guidance data may be transferred to SMTP server 670 along with data indicating the e-mail address associated with the subject. At SMTP server 670 an e-mail may be assembled and directed to the stored e-mail address through network 510. Furthermore, the information about how to purchase the beauty product included in the email may include a hyperlink to a location from which the beauty product may be ordered.

It will be appreciated that a system in accordance with an embodiment of the invention can be constructed in whole or in part from special purpose hardware or a general purpose computer system, or any combination thereof. Any portion of such a system may be controlled by a suitable program. Any program may in whole or in part comprise part of or be stored on the system in a conventional manner, or it may in whole or in part be provided in to the system over a network or other mechanism for transferring information in a conventional manner. In addition, it will be appreciated that the system may be operated and/or otherwise controlled by means of information provided by an operator using operator input elements which may be connected directly to the system or which may transfer the information to the system over a network or other mechanism for transferring information in a conventional manner.

This application may discuss beauty products in connection with use by women. However, it is to be understood that such discussions are for exemplary purposes only. It is to be understood that the invention is equally applicable to all genders, and is not necessarily limited to the beauty industry. It is also to be understood that any functional aspect of the invention can be implemented via any location in the system or network, and data software may be resident at any location either in a network, at a stand-alone site, or on media in the custody and control of a user or subject.

It is to be further understood that the physical mechanisms (e.g. hardware, software, networks, systems) for implementing the methods of the invention are many. Networks, hardware and systems can be configured in a host of ways with software and hardware functionality residing at many alternative locations. In addition, systems other than the exemplary systems disclosed might be used to implement the invention. Therefore, it is to be understood that the methods of the invention are not limited to any particular structure.

Further, methods or portions thereof can be implemented in either an electronic environment, a physical environment, or combinations thereof. Thus, for example, although one or more portions of a method may occur in an electronic environment, a “purchase” portion of the method may occur in a brick and mortar store, or vice versa.

### CROSS-REFERENCE TO CONCURRENTLY FILED APPLICATIONS AND GLOBAL DEFINITIONS

This application claims priority on and incorporates by reference the following U.S. Provisional applications: Artificial Intelligence For Use In Cosmetic And Non-Cosmetic Environments, Application No. 60/325,561 (provisional filed Oct. 1, 2001); and Methods And Systems For Cosmetic And Non-Cosmetic Product Selection, Application No. 60/325,559 (provisional filed Oct. 1, 2001).

The following concurrently filed U.S. patent applications are also incorporated herein by reference: Body Image Enhancement, Attorney Docket No. 05725.0972; Methods And Systems For Predicting And/Or Tracking Changes In External Body Conditions, Attorney Docket No. 05725.0973; Methods And Systems For Generating A Prognosis, Attorney Docket No. 05725.0974; Historical Beauty Record, Attorney Docket No. 05725.0975; Identification And Presentation Of Analogous Beauty Case Histories, Attorney Docket No. 05725.0976; Interactive Beauty Analysis, Attorney Docket No. 05725.0977; Feature Extraction In Beauty Analysis, Attorney Docket No. 05725.0978; Simulation Of An Aesthetic Feature On A Facial Image, Attorney Docket No. 05725.0979; Beauty Advisory System And Method, Attorney Docket No. 05725.0980; Virtual Beauty Consultant, Attorney Docket No. 05725.0981; Calibrating Image Capturing, Attorney Docket No. 05725.0982; Use Of Artificial Intelligence In Providing Beauty Advice, Attorney Docket No. 0572.0983; Shop-In-Shop Website Construction, Attorney Docket No. 05725.0984; Early Detection Of Beauty Treatment Progress, Attorney Docket No. 05725.0985; Cosmetic Affinity Indexing, Attorney Docket No. 05725.0986; Methods And Systems Involving Simulated Application Of Beauty Products, Attorney Docket No. 05725.1008; Customized Beauty Tracking Kit, Attorney Docket No. 05725.1009; Analysis Using Three-Dimensional Facial Image Attorney Docket No. 05725.1010; Body Image Templates With Pre-Applied Beauty Products, Attorney Docket No. 05725.1011; and Image Capture Method, Attorney Docket No. 05725.1012.

To the extent not inconsistent with the invention defined herein, definitions and terminology usage in the above-mentioned concurrently filed applications, the above-mentioned priority applications, and the following global definitions are to be considered in interpreting the language of this patent and the claims herein. Where multiple definitions are provided, they should be considered as a single cumulative definition.

The term “image” may include one or more of two-dimensional and three-dimensional representations. In certain examples consistent with the invention, a plurality of images from different perspectives may be used to construct a three-dimensional image. In a broader sense, only a single image may be used. Depending on the embodiment, the term “image” may include either a visually perceptible image or electronic image data that may be either used to construct a visually perceptible image or to derive information about the subject. The image may be a body image corresponding to an anatomical portion of the subject, and may represent, for example, the subject's entire face, or a portion of the subject's face. The image may be a detailed picture (e.g., a digital image or a photograph) of a portion of the subject's body and/or a topological plot mapping contours of a portion of subject's body. If the image is representative of an external body condition, the image could be either an actual image showing the condition or an image including symbolizations of the condition, for example. The image may be an actual or a simulated image. Simulated images may include wholly or partially generated computer images, images based on existing images, and images based on stored features of a subject.

The term “image capture device”, similar terms, and terms representing structures with similar functions may include one or more of a digital camera, webcam, film camera, analog camera, digital video camera, scanner, facsimile machine, copy machine, infrared imager, ultra-sound imaging device, or any other mechanism for acquiring an image of a subject's external body condition, an image of the subject's countenance, an/or an image of the subject's skin. An ultrasonic device might provide skin thickness information, or it might create a map on an area of the external location. Thus, the term “image” as used herein may be broader than a picture. Combinations of image capture devices may be used. For example, an image captured on photographic paper using a film camera might then be scanned on a flat bed scanner to create another image.

The term “capturing (an image)”, or any form thereof, refers to the use of an image capture device to acquire an image. “Capturing” may refer to the direct act of using the image capture device to acquire the image. It may also include indirect acts to promote acquisition. To this end, “capturing” may include the indirect acts of providing access to hardware, or to at least one of a client-based algorithm and a server-based algorithm for causing the image capture device to capture an image. This may be accomplished by providing a user with software to aid in the image capture process, or providing the user with access to a network location at which the software resides. Also consistent with certain embodiments of the invention, capturing may include at least one of receiving an instruction from the subject to capture an image, indicating to the subject before the image is captured, and indicating to the subject when the image is captured.

The term “image processing technique” or similar terms, may include a software program, computer, application specific integrated circuit, electronic device and/or a processor designed to identify in an image one or more characteristics, such as a skin condition. Such techniques may involve binarization, image partitioning, Fourier transforms, fast Fourier transforms (FFTs), and/or discrete cosine transforms may be performed on all or part of the image, resulting in coefficients. Based on the coefficients, conditions may be located, as known in the art. Artificial intelligence, such as fuzzy logic, neural networks, genetic programming and decision tree programming, may also be used to identify conditions. Alternatively, one or more digital filters may be passed through the image for locating specific conditions. These examples are provided for illustrative purposes with the understanding that any image processing technique may be used.

The term “network interface” or similar terms, refer to any mechanism for aiding communications between various nodes or locations in a network. A network interface may include, for example a bus, a modem, or any other input/output structure. A network interface may permit a connection to any network capable of being connected to an input and/or output module located within at least one or more of the following exemplary networks: an Ethernet network, an Internet Protocol network, a telephone network, a radio network, a cellular network, or any mechanism for permitting communication between two or more modes or remote locations. In some invention embodiments, a network interface might also included a user interface.

The term “user interface” may include at least one component such as a keyboard, key pad, mouse, track ball, telephone, scanner, microphone, touch screen, web cam, interactive voice response system (IVR), voice recognition system or any other suitable input mechanism for conveying information. A user interface may also include an input port connected by a wired, optical, or wireless connection for electromagnetic transmissions. In some embodiments, a user interface may include connections to other computer systems to receive the input commands and data therefrom. User interface may further include a data reading device such as a disk drive for receiving input data from and writing data to storage media such as magnetic and optical disks.

As used herein terms such as “external body condition”, “skin condition”, and “actual condition” refer to conditions of at least one of the skin, teeth, hair, eyebrows, eyelashes, body hair, facial hair, fingernails, and/or toenails, or any other externality. Examples of skin conditions may include elasticity, dryness, cellulitis, sweating, aging, wrinkles, melanoma, exfoliation, desquamation, homogeneity of color, creases, liver spots, clarity, lines, micro-circulation, shininess, softness, smoothness, tone, texture, matitty, hydration, sag, suppleness, stress, springiness, firmness, sebum production, cleanliness, translucency, luminosity, irritation, redness, vasocolation, vasomotion, vasodilation, vasoconstriction, pigmentation, freckles, blemishes, oiliness, pore distribution, pore size, moles, birthmarks, acne, blackheads, whiteheads, pockmarks, warts, pustules, boils, blisters, marks, smudges, specks, psoriasis and other characteristics associated with the subject's skin. Examples of hair conditions may include keratin plug, length, dryness, oiliness, dandruff, pigmentation, thickness, density, root conditions, split ends, hair loss, hair thinning, scales, staging, cleanliness and other properties related to the subject's hair. Examples of fingernail and toenail conditions may include onychomycosis, split nails, delaminating, psoriasis, brilliancy, lines, spots, coloration, gloss, strength, brittleness, thickness, hangnail, length, disease, and other characteristics related to the subject's nails. Other conditions may include, for example, size and proportion of facial features, teeth discoloration, and any other aesthetic-related or physical, physiological, or biological conditions of the user.

“Enabling”, “facilitating”, and “causing” an action refer to one or more of a direct act of performing the action, and any indirect act of encouraging or being an accessory to the action. Thus, the terms include partnering or cooperating with an entity who performs the action and/or referring commerce to or having commerce referred from an entity who performs the action. Other examples of indirect activity encompassed within the definitions of “enabling”, “facilitating”, and “causing” may include providing a subject with one or more of tools to knowingly aid in performing the action, providing instructions on how to perform the action, providing prompts or cues to perform the action, or expressly encouraging performance of the action. Indirect activity may also include cooperating with an entity who either directly performs the action or who helps another perform the action. Tools may include software, hardware, or access (either directly, through hyperlink, or some other type of cooperation or partnering) to a network location (e.g., web site) providing tools to aid in performing the action. Thus, phrases such as “enabling access” and “enabling display” do not necessary require that the actor actually access or display anything. For example, the actor may perform the enabling function by affiliating with an entity who performs the action, or by providing instructions, tools, or encouragement for another to do the accessing and displaying.

Forms of the word “displaying” and like terms may also include indirect acts such as providing content for transmission over a network to a display device, regardless of whether the display device is in the custody or control of the sender. Any entity in a chain of delivering information for display performs an act of “displaying”, as the term is used herein.

Likewise, the term “providing” includes direct and indirect activities. For example, providing access to a computer program may include at least one of providing access over a network to the computer program, and creating or distributing to the subject a computer program configured to run on the subject's workstation or computer. For example, a first party may direct network traffic to (either through electronic links or through encouragement to visit) a server or web site run by a second party. If the second party maintains a particular piece of software thereon, then it is to be understood that within the meaning of “providing access” as used herein, the first party is said to provide access to the particular software. Or if the first party directs a subject to a second party who in turn ships the particular software to the user, the first party is said to provide the user with access to the particular software. (Of course, in both of the above instances, the second party would also be providing access within the meaning of the phrase as used herein.) “Receiving” may include at least one of acquisition via a network, via verbally communication, via electronic transmission, via telephone transmission, in hard-copy form, or through any other mechanism enabling reception. In addition, “receiving” may occur either directly or indirectly. For example, receipt may occur through a third party acting on another party's behalf, as an agent of another, or in concert with another. Regardless, all such indirect and direct actions are intended to be covered by the term “receiving” as used herein. A received request, for example, may take one of many forms. It may simply be a checked box, clicked button, submitted form or oral affirmation. Or it might be a typed or handwritten textual request. Receiving may occur through an on-line interest form, e-mail, facsimile, telephone, interactive voice response system, or file transfer protocol transmitted electronically over a network at a web site, an internet protocol address, or a network account. A request may be received from a subject for whom information is sought, or an entity acting on the subject's behalf. “Receiving” may involve receipt directly or indirectly through one or more networks and/or storage mediums. Receipt may occur physically such as in hard copy form, via mail delivery or other courier delivery.

Forms of the word “maintain” are used broadly to include gathering, storing, accessing, providing access to, or making something available for access, either directly or indirectly. For example, those who maintain information include entities who provide a link to a site of a third party where the information is stored.

Consistent with the concepts set forth above, all other recited actions such as, for example, obtaining, determining, generating, selecting, applying, simulating, presenting, etc, are inclusive of direct and indirect actions. Thus, for purposes of interpreting the following claims, an entity performs a recited action through either direct or indirect activity. Further examples of indirect activity include sending signals, providing software, providing instructions, cooperating with an entity to have the entity perform the action, outsourcing direct or indirect actions, or serving in any way as an accessory to the specified action.

The term “product” is used to generically refer to tangible merchandise, goods, services, and actions performed. A “beauty product,” “beauty care product,” “cosmetic product” or similar terms, refer to products (as defined above) for effecting one or more external body conditions, such as conditions of the skin, hair and nails. Examples of tangible merchandise forms of beauty products include cosmetic goods, such as treatment products, personal cleansing products, and makeup products, in any form (e.g., ointments, creams, gels, sprays, supplement, ingesta, inhalants, lotions, cakes, liquids, and powders.)

Examples of services forms of beauty products include hair styling, hair cutting, hair coloring, hair removal, skin treatment, make-up application, and any other offering for aesthetic enhancement. Examples of other actions performed include massages, facial rubs, deep cleansings, applications of beauty product, exercise, therapy, or any other action effecting the external body condition whether performed by a professional, the subject, or an acquaintance of the subject.

The following is exemplary and non-exhaustive listing of a few beauty products—scrubs, rinses, washes, moisturizers, wrinkle removers, exfoliates, toners, cleansers, conditioners, shampoos, cuticle creams, oils, and anti-fungal substances, anti-aging products, anti-wrinkle products, anti-freckle products, skin conditioners, skin toners, skin coloring agents, tanners, bronzers, skin lighteners, hair coloring, hair cleansing, hair styling, elasticity enhancing products, agents, blushes, mascaras, eyeliners, lip liners, lipsticks, lip glosses, eyebrow liners, eye shadows, nail polishes, foundations, concealers, dental whitening products, cellulite reduction products, hair straighteners and curlers, and weight reduction products. A beauty care treatment regimen may involve the administration of one or more products, as defined above.

The terms “beauty advice”, “beauty guidance”, and similar terms are used interchangeably to refer to the provision of beauty related information to a subject. Advice or guidance includes one or more of beauty product recommendations (e.g., cosmetic product recommendations for products to treat conditions the subject is prompted to evaluate), remedial measures, preventative measures, predictions, prognoses, price and availability information, application and use information, suggestions for complementary products, lifestyle or dietary recommendations, or any other information intended to aid a subject in a course of future conduct, to aid a subject in understanding past occurrences, to reflect information about some future occurrences related to the subject's beauty or to aid a subject in understanding beauty products, as defined above.

The term “network” may include a public network such as the Internet or a telephony network, a private network, a virtual private network, or any other mechanism for enabling communication between two or more nodes or locations. The network may include one or more of wired and wireless connections. Wireless communications may include radio transmission via the airwaves, however, those of ordinary skill in the art will appreciate that various other communication techniques can be used to provide wireless transmission including infrared line of sight, cellular, microwave, satellite, blue-tooth packet radio and spread spectrum radio. Wireless data may include, but is not limited to, paging, text messaging, e-mail, Internet access and other specialized data applications specifically excluding or including voice transmission.

In some instances consistent with the invention, a network may include a courier network (e.g. postal service, United Parcel Service, Federal Express, etc.). Other types of networks that are to be considered within the scope of the invention include local area networks, metropolitan area networks, wide area networks, ad hoc networks, or any mechanism for facilitating communication between two nodes or remote locations.

“Artificial intelligence” (AI) is used herein to broadly describe any computationally intelligent systems that combine knowledge, techniques, and methodologies. An AI engine may be any system configured to apply knowledge and that can adapt itself and learn to do better in changing environments. Thus, the AI engine may employ any one or combination of the following computational techniques: neural network, constraint program, fuzzy logic, classification, conventional artificial intelligence, symbolic manipulation, fuzzy set theory, evolutionary computation, cybernetics, data mining, approximate reasoning, derivative-free optimization, decision trees, or soft computing. Employing any computationally intelligent techniques, the AI engine may learn to adapt to unknown or changing environment for better performance. AI engines may be implemented or provided with a wide variety of components or systems, including one or more of the following: central processing units, co-processors, memories, registers, or other data processing devices and subsystems.

AI engines may be trained based on input such as product information, expert advice, user profile, or data based on sensory perceptions. Using input an AI engine may implement an iterative training process. Training may be based on a wide variety of learning rules or training algorithms. For example, the learning rules may include one or more of the following: back-propagation, real-time recurrent learning, pattern-by-pattern learning, supervised learning, interpolation, weighted sum, reinforced learning, temporal difference learning, unsupervised learning, or recording learning. As a result of the training, AI engine may learn to modify its behavior in response to its environment, and obtain knowledge. Knowledge may represent any information upon which AI engine may determine an appropriate response to new data or situations. Knowledge may represent, for example, relationship information between two or more products. Knowledge may be stored in any form at any convenient location, such as a database.

Since AI engine may learn to modify its behavior, information describing relationships for a universe of all combinations of products may not need to be maintained by the AI engine or any other component of the system.

“Personal information”, “subject specific information”, “user specific information”, “user profile”, “personal characteristics”, “personal attributes”, “profile information”, and like terms (collectively referred to in this section as “personal information”) may broadly encomp4ass any information about the subject or user. Such information may, for example, fall within categories such as physical characteristics, fashion preferences, demographics, nutritional information, cosmetic usage information, medical history information, environmental information, beauty product usage information, lifestyle, and may include information such as name; age; birth date; height; weight; ethnicity; eating habits; vacation patterns; geographic location of the individual's residence, location, or work; work habits; sleep habits; toiletries used; exercise habits; relaxation habits; beauty care habits; smoking and drinking habits; sun exposure habits; use of sunscreen; propensity to tan; number of sunburns and serious sunburns; dietary restrictions; dietary supplements or vitamins used; diagnosed conditions affecting the external body, such as melanoma; an image, such as a picture or a multimedia file of the subject; facial feature characteristics; family history information such as physical characteristics information about relatives of the subject (e.g., premature balding, graying, wrinkles, etc.); external body condition (as defined previously); color preferences, clothing style preferences, travel habits; entertainment preferences; fitness information; adverse reactions to products, compounds, or elements (e.g., sun exposure); body chemistry, use of prior beauty care products and their effectiveness; purchasing, shopping, and browsing habits; hobbies; marital status; whether the subject is a parent; country of residence; region of residence; birth country and region; religious affiliation; political affiliation; whether the subject is an urban dweller suburban dweller or rural area dweller; size of urban area in which the subject lives; whether the subject is retired; annual income, sexual preference, or any other information reflecting habits, preferences, or affiliations of the subject.

Personal information may also include information electronically gleaned by tracking the subject's electronic browsing or purchasing habits, or as the result of cookies maintained on the subject's computer, responses to surveys, or any other mechanism providing information related to the subject. In addition, personal information may be gathered through non-electronic mechanisms such as hard copy surveys, personal interviews, or consumer preference polls.

“Complementary” and “complementary product” refers to one or more of physical, physiological, biologically, and aesthetic compatibility. A product may be complementary with one or more of another product, a group of products, or a subject. In that latter instance, whether a product is considered “complementary” may be a function of personal information of the subject. Thus, for example a product may be complementary if it is unlikely to cause an adverse allergic reaction; if it physically blends well with another product; or if it is aesthetically consistent with the subject or one or more other products. Aesthetic compatibly may refer to the fact that two products are aesthetically appealing (or do not clash) when worn together. The identification of a complementary product may also be based on product characteristics, user preferences, survey data, or expert advice.

As used herein, the words “may” and “may be” are to be interpreted in an open-ended, non-restrictive manner. At minimum, “may” and “may be” are to be interpreted as definitively including structure or acts recited. Further, the word “or” is to be interpreted in the conjunctive and the disjunctive.

While flow charts presented herein illustrate a series of sequential blocks for exemplary purposes, the order of blocks is not critical to the invention in its broadest sense. Further, blocks may be omitted and others added without departing from the spirit of the invention. Also, the invention may include combinations of features described in connection with differing embodiments.

Although a focus of the disclosure may be on server-side methods, it is nevertheless to be understood that the invention includes corresponding client-side methods, software, articles of manufacture, and computer readable media, and that computer readable media can be used to store instructions for some or all of the methods described herein. Further, it is to be understood that disclosed structures define means for implementing the functionality described herein, and that the invention includes such means for performing the disclosed functions.

In the foregoing Description of Exemplary Embodiments, various features are grouped together in a single embodiment for purposes of streamlining the disclosure. This method of disclosure is not to be interpreted as reflecting an intention that the claimed invention requires more features than are expressly recited in each claim. Rather, as the following claims reflect, inventive aspects lie in less than all features of a single foregoing disclosed embodiment. Thus, the following claims are hereby incorporated into this Description of the Exemplary Embodiments, with each claim standing on its own as a separate embodiment of the invention.

What is claimed is:

1. A method of providing guidance for a subject, the method comprising:
receiving profile information about the subject, the profile information reflecting at least one of physical attribute information and lifestyle information;
receiving information reflecting a classification relating to birth of the subject; and
providing guidance for the subject, the guidance at least including beauty advice and being a function of at least some of the profile information and the birth-related classification.

2. The method of claim 1, wherein the birth-related classification is an astrological horoscope sign of the subject.

3. The method of claim 1, wherein the birth-related classification is at least one of an astrological horoscope sign, a karma classification, a Chinese zodiac sign, an Indian zodiac sign, a Charkas classification, a numerology classification, and a classification based on a way a planetary system was arranged when the subject was born.

4. The method of claim 1, further comprising using the profile information to categorize the subject in at least one of a plurality of predefined categories, and wherein the guidance is provided as a function of the at least one predefined category and the birth-related classification of the subject.

5. The method of claim 4, wherein the plurality of predefined categories are organized as subcategories beneath the birth-related classification.

6. The method of claim 4, wherein the plurality of predefined categories are organized independent of the birth-related classification.

7. The method of claim 1, wherein the information reflecting a birth-related classification of the subject includes at least one of the subject's birthday and a predefined birth-related classification sign.

8. The method of claim 5, wherein the predefined birth-related classification sign is an identification of the subject's astrological sign.

9. The method of claim 1, further comprising prompting the subject to provide profile information, the prompting including posing to the subject a plurality of questions seeking physical attribute information about at least one of the subject's hair, skin, eyes, and facial features.

10. The method of claim 1, further comprising prompting the subject to provide profile information, the prompting including presenting to the subject a plurality of questions seeking lifestyle information about at least one of the subject's vocation, preferred colors, hobbies, physical fitness, eating habits, cosmetic usage habits, cosmetic preferences, and apparel preferences.

11. The method of claim 1, conducted over a network, wherein the profile information is received at a server side and the guidance advice is provided to a client side.

12. The method of claim 1, wherein the guidance includes a recommendation to use a beauty product.

13. The method of claim 12, further comprising offering the beauty product for sale to the subject.

14. The method of claim 12, wherein the guidance for the subject and the offer for sale are communicated to the subject over a network.

15. The method of claim 1, wherein providing guidance to the subject includes providing at least one prediction identified as being based on the birth-related classification.

16. The method of claim 15, wherein the at least one prediction is identified as being astrologically based.

17. The method of claim 15, wherein the at least one prediction includes a recommendation to use at least one beauty product.

18. The method of claim 15, wherein the at least one beauty product bears a brand name pre-identified by the subject.

19. The method of claim 15, wherein the beauty advice is integrated into the birth-related classification prediction.

20. The method of claim 15, wherein the beauty advice is presented independent of the birth-related classification prediction.

21. The method of claim 15, wherein the birth-related classification prediction includes a suggestion that a course of future events may change based on use of certain beauty products.

22. The method of claim 15, wherein the birth-related classification prediction correlates a use of at least one specified beauty product with a predicted future occurrence.

23. The method of claim 15, wherein the birth-related classification prediction correlates a failure to use at least one specified beauty product with a predicted future occurrence.

24. The method of claim 1, wherein the beauty advice includes information on how to apply at least one beauty product.

25. The method of claim 1, further comprising storing at least some of the received profile information, information reflecting the birth-related classification of the subject, and an address of the subject, and wherein the method further comprises periodically providing guidance to the subject through the subject's stored address.

26. The method of claim 25, wherein the address is an e-mail address, the method further comprising sending to the subject's e-mail address a birth-related classification prediction, information about a beauty product, and information about how to purchase the beauty product.

27. The method of claim 26, wherein the information about how to purchase the beauty product includes a hyperlink to a location from which the beauty product may be ordered.

28. The method of claim 25, wherein the address is an address of a mobile receiver/transmitter of the subject, the method further comprising sending to the subject's mobile address a birth-related classification prediction, information about a beauty product, and information about how to purchase the beauty product via the mobile receiver.

29. The method of claim 1, further comprising storing an identification code of the subject, so that the user is enabled to receive selective guidance after accessing a website using the identification code.

30. The method of claim 1, wherein the guidance is further a function of at least one of a demographic location of the subject and an environmental condition at a demographic location of the subject.

31. The method of claim 1, wherein providing guidance includes providing the subject with at least one prediction associated with the birth-related classification, and thereafter providing beauty advice in response to a request by the subject.

32. The method of claim 1, further comprising establishing an association between a beauty product supplier and a provider of birth-related classification information, such that when the subject accesses a website of the beauty product supplier, information of the provider is presented to the subject.

33. The method of claim 1, further comprising establishing an association between a beauty product supplier and a provider of birth-related classification information, such that when the subject accesses a site of the beauty product supplier, a hyperlink to the provider is displayed.

34. The method of claim 1, further comprising maintaining a plurality of beauty recommendations organized at least in part by birth-related classification, and wherein providing guidance for the subject includes dispensing at least one of the beauty recommendations.

35. The method of claim 34, wherein the plurality of beauty recommendations are further organized by categories defined by one or more of personal attribute information and personal lifestyle information.

36. A method for providing guidance to a subject, the method comprising:
establishing a set of criteria for classifying the subject in at least one of a plurality of predefined categories, the criteria including at least one of personal attribute information and lifestyle information;
advising the subject of the at least one predefined categories into which the subject is classified; and
dispensing guidance including beauty advice, the guidance being a function of a birth-related classification of the subject and the at least one predefined category into which the subject is classified.

37. The method of claim 36, wherein the birth-related classification is an astrological horoscope sign.

38. The method of claim 36, wherein the birth-related classification is at least one of an astrological horoscope sign, a karma classification, a Chinese zodiac sign, an Indian zodiac sign, a Charkas classification, a numerology classification, and a classification based on a way a planetary system was arranged when the subject was born.

39. The method of claim 36, wherein the guidance is dispensed through at least one of electronic messaging, website posting, mailing, print media, television media, radio media, and paid advertisements.

40. The method of claim 39, wherein the guidance is dispensed at a regular interval.

41. The method of claim 36, wherein the dispensed guidance combines advice based on the birth-related classification with beauty advice.

42. The method of claim 36, wherein the dispensed guidance combines astrological horoscope advice with beauty advice.

43. The method of claim 36, wherein the beauty advice includes a recommendation to purchase at least one beauty product.

44. The method of claim 36, wherein the plurality of predefined categories are organized as subcategories beneath the birth-related classification.

45. The method of claim 36, wherein the plurality of predefined categories are organized independent of the birth-related classification.

46. The method of claim 36, wherein personal attribute information characterizes at least one of the subject's hair, skin, eyes, and facial features.

47. The method of claim 36, wherein the lifestyle information characterizes at least one of the subject's vocation, preferred colors, hobbies, physical fitness, eating habits, cosmetic usage habits, cosmetic preferences, and apparel preferences.

48. The method of claim 41, wherein the birth-related classification advice includes a suggestion that a course of future events may change based on use of certain beauty products.

49. The method of claim 41, wherein the birth-related classification advice correlates a use of at least one specified beauty product with a predicted future occurrence.

50. The method of claim 41, wherein the birth-related classification advice correlates a failure to use at least one specified beauty product with a predicted future occurrence.

51. The method of claim 36, further comprising maintaining a plurality of beauty recommendations organized at least in part by birth-related classification, and wherein dispensing guidance for the subject includes dispensing at least one of the beauty recommendations.

52. The method of claim 36, wherein the plurality of beauty recommendations are further organized by categories defined by one or more of personal attribute information and personal lifestyle information.

53. A method of marketing beauty products, the method comprising:
receiving profile information about a subject, the profile information reflecting at least one of physical attribute information and lifestyle information about the subject;
identifying a birth-related classification of the subject; and
recommending at least one beauty product to the subject as a function of the birth-related classification of the subject and at least some of the received profile information.

54. The method of claim 53, wherein the birth-related classification is at least one of an astrological horoscope sign, a karma classification, a Chinese zodiac sign, an Indian zodiac sign, a Charkas classification, a numerology classification, and a classification based on a way a planetary system was arranged when the subject was born.

55. A method of marketing beauty products, the method comprising:
receiving profile information about a subject, the profile information reflecting at least one of physical attribute information and lifestyle information about the subject;
receiving information reflective of an astrological horoscope sign of the subject; and
recommending at least one beauty product to the subject as a function of the subject's astrological horoscope sign and at least some of the received profile information.

56. A method of marketing beauty products, the method comprising:
maintaining a first website offering for sale beauty products;
establishing a relationship between the first website and a second website dispensing birth-related classification information;
providing to a user of the second website a recommendation to use a beauty product offered for sale through the first website, the recommendation being a function of a birth-related classification of the user; and
providing on the second website a link to the first website, and informing the user of the second website of the ability to purchase the beauty product through the link to the first website.

57. The method of claim 56, wherein the birth-related classification is at least one of an astrological horoscope sign, a karma classification, a Chinese zodiac sign, an Indian zodiac sign, a Charkas classification, a numerology classification, and a classification based on a way a planetary system was arranged when the subject was born.

58. The method of claim 56, wherein providing a recommendation includes presenting to the user information indicated as being associated with an astrological horoscope and which also contains the recommendation to use a beauty product.

59. A system of providing guidance for a subject, the system comprising:
a component for receiving profile information about the subject, the profile information reflecting at least one of physical attribute information and lifestyle information;
a component for receiving information reflecting a birth-related classification of the subject; and
a component for providing guidance for the subject, the guidance at least including beauty advice and being a function of at least some of the profile information and the subject's birth-related classification.

60. The system of claim 59, further comprising a component for using the profile information to categorize the subject in at least one of a plurality of predefined categories, and wherein the guidance is provided as a function of the at least one predefined category and the birth-related classification of the subject.

61. The system of claim 60, wherein the plurality of predefined categories are organized as subcategories beneath the birth-related classification.

62. The system of claim 60, wherein the plurality of predefined categories are organized independent of birth-related classification.

63. The system of claim 59, wherein the information reflecting a birth-related classification includes at least one of the subject's birthday and an identification of the subject's astrological sign.

64. The system of claim 59, conducted over a network, wherein the profile information is received at a server side and the guidance advice is provided to a client side.

65. The system of claim 59, wherein the guidance includes a recommendation to use a beauty product.

66. The system of claim 65, further comprising offering the beauty product for sale to the subject.

67. A method of providing guidance for a subject, the method comprising:
receiving profile information about the subject, the profile information reflecting at least one of physical attribute information and lifestyle information;
receiving information reflecting at least one of when and where the subject was born; and
providing guidance for the subject, the guidance at least including beauty advice and being a function of at least some of the profile information and the and a classification correlating to at least one of when and where the subject was born.

68. The method of claim 67, wherein the classification is at least one of an astrological horoscope sign, a karma classification, a Chinese zodiac sign, an Indian zodiac sign, a Charkas classification, a numerology classification, and a classification based on a way a planetary system was arranged when the subject was born.

69. The method of claim 67, wherein the classification is based on an abstraction lacking a relationship to a scientific principle.
